(19) United States
(12) Patent Application Publication
(10) Pub. No.: US 2008/0061978 A1
(43) Pub. Date: Mar. 13, 2008

(54) MOVING OBJECT LOCATING APPARATUS

(76) Inventor: Dennis HUANG, Taipei (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/620,812

(22) Filed: Jan. 8, 2007

(30) Foreign Application Priority Data
Aug. 31, 2006 (TW) 095215443

(51) Int. Cl. G08B 13/14; G08B 1/08; G08B 23/00; G08B 5/22

(52) U.S. Cl. 340/572.1; 340/573.3; 340/539.32; 340/825.49

(57) ABSTRACT

The present invention relates to a moving object locating apparatus that comprises a search unit and at least one target unit. The first central processing unit is configured to proceed with coding, and the antenna module is configured to transmit searching signals that carry identification codes. The target unit, which is provided with a default identification code, comprises a radio transmit-receive unit, a second central processing unit and a second power unit. When the radio transmit-receive unit receives the searching signal, the second central processing unit will decode the identification code carried by the searching signal and matches with the default identification code of the target unit. When two codes are matched, the second central processing unit then will proceed to coding and then actuate the radio transmit-receive unit to transmit a response signal, which carries the default identification code, back to the search unit.

### BACKGROUND OF THE INVENTION

1. Field of the Invention

The present invention relates to a moving object locating apparatus and, more particularly, to a moving object locating apparatus having an omni-directional antenna along with a directional antenna.

2. Description of Related Art

Most of the conventional pet search systems comprise of a search unit and a target unit. The target unit is mounted on a pet, such that whenever a pet goes missing or moves beyond the pet owner's sight, the pet owner can utilize the search unit by sending out a searching signal. Upon receiving the searching signal, the target unit will respond with a response signal that permits the pet owner to retrieve the lost pet.

In practice, however, the conventional pet search systems are ineffective in finding the lost pet since the target unit that is placed on a pet keeps sending signals to the search unit and consumes power regardless of whether the pet is lost. Therefore, if the pet actually goes missing, the batteries on the target unit have often run out and as a result cannot be operated properly.

Also, the search unit in the conventional pet search systems is provided only with a single antenna for transmitting and receiving signals, which in fact is insufficient to accurately locate the position of the lost pet, and the pet owner often will not be able to retrieve the lost pet.

Therefore, it is necessary to come up with an improvement to overcome the above deficiencies in the conventional systems.

### SUMMARY OF THE INVENTION

The present invention provides a moving object locating apparatus, which comprises a search unit and at least one target unit. The target unit can be mounted on pets, e.g. dogs, cats and other pets that need to be monitored. When a pet goes missing or moves beyond the pet owner's sight, the pet owner may utilize the search unit by sending a searching signal to the target unit mounted on the pet. Upon receiving the searching signal, the target unit then will respond to the search unit with a response signal that will guide the pet owner to reunite with the lost pet.

The present invention mainly comprises a search unit and at least one target unit. A search unit can be assigned to one target unit or more than one target unit.

The search unit comprises a first central processing unit, an antenna module and a first power unit. The first central processing unit is configured to proceed with coding, and the antenna module is configured to transmit searching signals that carry identification codes. The target unit, which is provided with a default identification code, comprises a radio transmit-receive unit, a second central processing unit and a second power unit. When the radio transmit-receive unit receives the searching signal, the second central processing unit will decode the identification code carried by the searching signal and matches with the default identification code of the target unit. When the two codes are matched, the second central processing unit will then proceed to coding and actuate the radio transmit-receive unit to transmit a response signal, which carries the default identification code, back to the search unit.

The search unit further comprises a switch, and the antenna module further comprises an omni-directional antenna and a directional antenna, to which the switch is connected respectively. The omni-directional antenna is first employed to search for the target unit. When the target unit is detected within a predetermined radius, the search unit will switch to the directional antenna with the switch as to conduct a more detailed search for the target unit.

The search unit in the present invention further comprises an alarm unit. When the search unit receives any response signal from the target unit, the alarm unit is initiated.

The target unit in the present invention further consists of a detection activating device. When the search unit approaches to the target unit, the detection activating device will start to operate.

The detection activating device sends out an alert by beeping, flashing, vibrating or other means that provide equivalent effects to notify the user. Also with the sound strength of the alarm, the user is able to locate the moving object more efficiently.

The search unit in the present invention further comprises an input device for inputting identification numbers. The input device can be a keyboard switch.

The search unit in the present invention further comprises a emitting strength adjustment that allows searching signals to be transmitted at the different levels of strength. For example, three kinds of signals are set with each having three different levels of strength from HIGH, MEDIUM to LOW. The searching signal with HIGH emitting strength is first transmitted. If any response signal can be captured, it implies the target unit is within the effective searching radius. The emitting strength then could be adjusted down to MEDIUM or LOW for further search. If the response signal still can be captured with MEDIUM or LOW emitting strength, it implies the target unit is within a closer range.

The search unit in the present invention further comprises a sensitivity adjustment that provides different levels of sensitivity upon reception. For example, three different levels of reception sensitivity are set from HIGH, MEDIUM to LOW. The HIGH reception sensitivity is first employed. If any response signal can be captured, it implies the target unit is within the effective searching radius. The reception sensitivity then could be adjusted down to MEDIUM or LOW for further search. If the response signal still can be captured with MEDIUM or LOW reception sensitivity, it implies the target unit is within a closer range.

Prior to reception of any searching signal, the target unit remains in the standby mode. The target unit in the present invention is configured to switch on the power and transmit response signals only upon reception of the searching signals, which ultimately saves significant energy, increases product endurance and extends the standby time of the apparatus.

The objects, advantages, and novel features of the invention will become more apparent from the following detailed description when taken in conjunction with the accompanying drawings.

### BRIEF DESCRIPTION OF THE DRAWINGS

FIG. 1 is a schematic drawing that illustrates the operation of the moving object locating apparatus according to a preferred embodiment of the present invention;

FIG. 2 is a function block diagram of the search unit according to a preferred embodiment of the present invention; and

FIG. 3 is a function block diagram of the target unit according to a preferred embodiment of the present invention.

### DETAILED DESCRIPTION OF THE PREFERRED EMBODIMENT

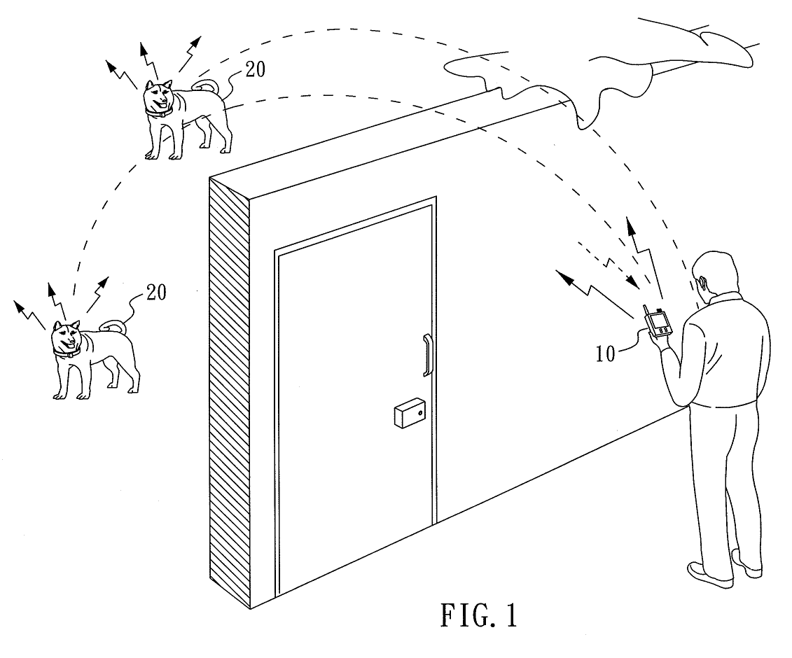

Referring to FIG. 1, which shows the structure and the components therein of the present invention, a moving object locating apparatus comprises a search unit 10 and at least one target unit 20. The search unit 10 can be assigned to one target unit 20 or can be assigned to a plurality of target units 20. FIG. 1, as an example, illustrates a search unit 10 being assigned to two target units 20.

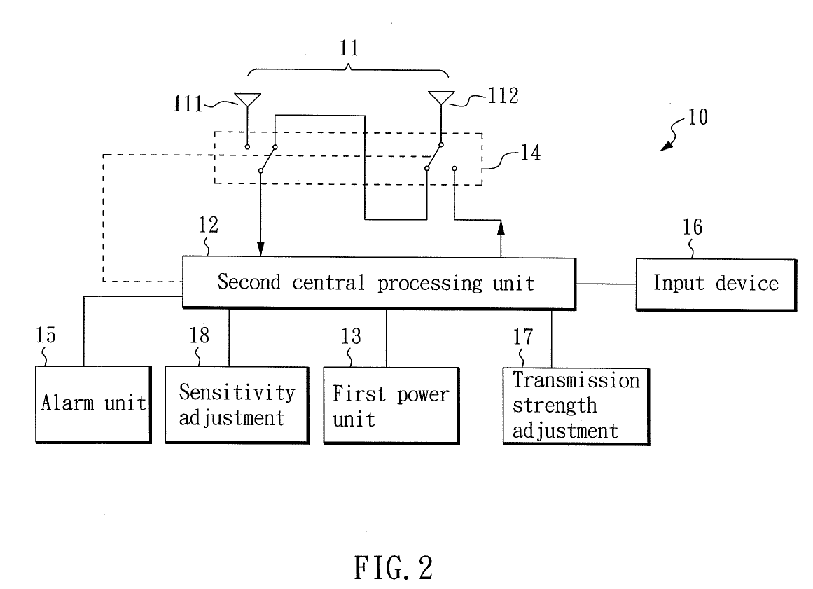

Referring to FIG. 2, the search unit 10 of the present invention mainly comprises an antenna module 11, a first central processing unit 12 and a first power unit 13. The first central processing unit 12 carries out a coding process, and a search signal that contains an identification code is transmitted through the antenna module 11. The search unit 10 further comprises an input device 16 that permits inputting of identification numbers. For the convenience of the user to adjust the transmission strength and the reception sensitivity, the search unit 10 further comprises a transmission strength adjustment 17 for adjusting the search signal transmission at different levels of strength and a sensitivity adjustment 18 for setting up different levels of sensitivity upon reception.

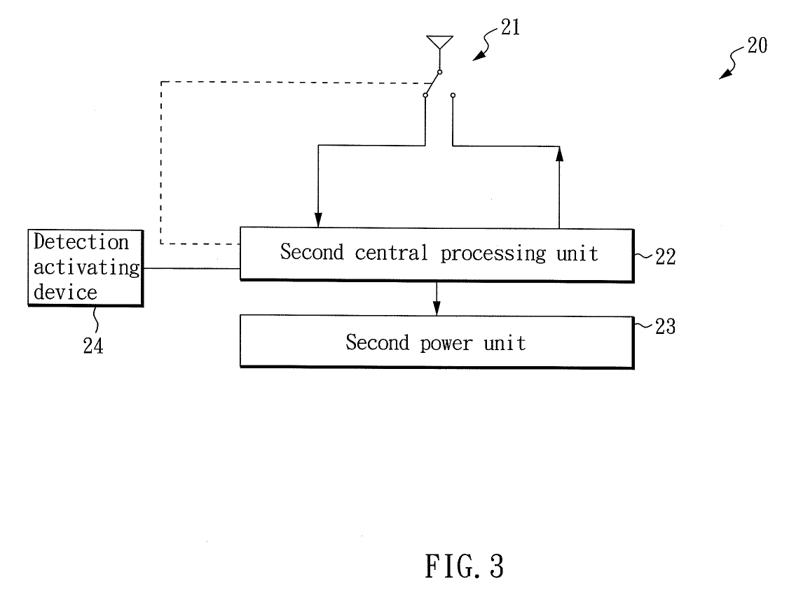

Referring to FIG. 3, the target unit 20 of the present invention mainly comprises a radio transmit-receive unit 21, a second central processing unit 22 and a second power unit 23. When the radio transmit-receive unit 21 of the target unit 20 receives the search signal from the search unit 10, the second central processing unit 22 will encode the identification code carried in that search signal and match the encoded identification code with the default identification code. When two codes are matched, the second central process unit 22 will proceed with coding and then actuate the radio transmit-receive unit 21 to transmit a response signal that carries the above default identification code back to the search unit 10.

The operation with respect to the present invention is illustrated together by FIG. 2 and FIG. 3. The search unit 10 of the present invention further comprises a switch 14 that can be operated along with the antenna module 11, which comprises an omni-directional antenna 111 and a directional antenna 112. The switch 14 is connected to the omni-directional antenna 111 and the directional antenna 112 respectively. The omni-directional antenna 111 is first employed to search for the target unit 20. When the target unit 20 is detected within a predetermined radius, the omni-directional antenna 111 will be switched to the directional antenna 112 with the switch 14 to perform a more detailed searching for the target unit 20. The search unit 10 has an alarm unit 15, which is initiated when receiving the response signal sent by the target unit 20. The alarm can be a buzzer, flashing light, vibration or other means that provides equivalent alarming effects. Likewise, as shown in FIG. 3, as the search unit 10 approaches the target unit 20, the detection activating device 24 of the target unit 20 is initiated.

An example in practice will be described in the followings with reference to FIG. 1. The target unit 20 can be worn around the neck of a dog that belongs to its owner. As the dog leaves the pet owner's sight, the search unit 10 can be utilized by the owner to send out a searching signal to locate the dog. The target unit 20 is in a standby mode in order to consume less energy. Once the target unit 20 receives the searching signal sent by the search unit 10, the target unit 20 will switch to a working mode, in which the target unit 20 will respond with a response signal back to the search unit 10 simultaneously, such that the pet owner will be able to be guided with the search unit 10 to retrieve the lost pet.

The first central processing unit 12 of the search unit 10 can proceed with coding based on the identification code of a target unit 20 to generate a baseband signal having such identification code. That baseband signal which carries the identification code then will be converted into a radio-frequency signal as the searching signal by the first central processing unit 12. The search signal will then be sent out with the omni-directional antenna 111 or the directional antenna 112 to search for the lost pet.

As mentioned above, the moving object locating apparatus of the present invention can be assigned to more than one target unit 20 at the same time, where each search unit 10 is provided with its exclusive identification code respectively for identification purposes.

Also referring to FIG. 1, FIG. 2 and FIG. 3 together, the search unit 10 in the present invention has both the omni-directional antenna 111 and the directional antenna 112 that can transmit searching signals which respectively carry identification codes for locating the target unit 20 placed on the pet. The omni-directional antenna 111 and the directional antenna 112 can also receive any incoming response signal sent by the target unit 20. The omni-directional antenna 111 can transmit and receive signals at a larger angle (approximately 360° radiation), whereas the directional antenna 112 can radiate in a more specific angle (aproximately 45°). In the present embodiment, a predetermined radius is set as a dividing margin, where the distance between the pet and the pet owner exceeds that predetermined radius, the omni-directional antenna 111 may first be employed for transmitting the searching signals, as well as for receiving any incoming response signals sent by the target unit 20. As the distance between the pet and the pet owner shortens to within the predetermined radius, the search unit 10 can switch to the directional antenna 112, as to receive any incoming response signals sent by the target unit 20 until the pet is retrieved.

When target unit 20 of the present invention is placed or worn on the pet, the target unit is operated in a standby mode, in which the target unit 20 would not actively transmitting any signal, as to effectively save energy.

Upon receiving the searching signal of the search unit 10 with the radio transmit-receive unit 21 of the target unit 20, the second central processing unit 22 will first convert the search signal as a radio-frequency signal into a baseband digital signal, after which the second central processing unit 22 will proceed to matching the baseband digital signal with the default identification code. If the two codes are matched, the target unit 20 will transmit a response signal having the identification code with the radio transmit-receive unit 21 to respond with the search unit 10 for locating the lost pet.

The antenna module 11 of the search unit 10 will later receive the response signal, which will then be verified by the first central processing unit 12. If the response signal is matched correctly, it implies that the response signal sent by the target unit 20 has been properly acknowledged. The first central processing unit 12 will then actuate the alarming unit 15 based on a signal strength index; the higher the signal strength index upon reception, the closer the target unit 20 to the search unit 10. In such a scenario, the first central processing unit 12 can actuate the alarming unit 15 to carry out a more intense alarm effect, such as continuous beeps or flashing.

As described above, the moving object locating apparatus of the present invention provides pet owners an easy and effective instrument to search for their pets. The target unit, which is placed on the pet, is operated in a standby mode and will be switched to a work mode only upon receiving any searching signal, as to save energy and to prevent the response signal not being able to be transmitted due to insufficient power. Also, the present invention utilizes the omni-directional to radiate signals for conducting a long-distance search and the directional antenna to radiate signals for conducting a short-distance search once the pet is within a predetermined radius from the pet owner, allowing pet owners to retrieve their pets very more efficiently.

It is to be appreciated that although the present invention is described above as being used for pets it could be used for other situations such as locating infant children, monitoring wildlife etc.

Although the present invention has been explained in relation to its preferred embodiment, it is to be understood that many other possible modifications and variations can be made without departing from the scope of the invention as hereinafter claimed.

What is claimed is:

1. A moving object locating apparatus comprising:
a search unit comprising a first central processing unit for coding, an antenna module configured to transmit searching signals which carry identification codes and a first power unit; and
at least one target unit provided with a default identification code comprising a radio transmit-receive unit, a second central processing unit and a second power unit; as said radio transmit-receive unit receives said searching signal, said second central processing unit decodes the identification code carried by said searching signal and matches with the default identification code of said target unit; when two codes are matched, said second central processing unit then proceeds to coding and actuates said radio transmit-receive unit to transmit a response signal, which carries said default identification code, back to said search unit.

2. The apparatus as claimed in claim 1, wherein said search unit further comprises a switch, and said antenna module further comprises an omni-directional antenna and a directional antenna, to which said switch is connected respectively; said omni-directional antenna is first employed to search for said target unit and then, when said target unit is detected within a predetermined radius, said omni-directional antenna is switched to said directional antenna with said switch for further searching.

3. The apparatus as claimed in claim 1, wherein said search unit further comprises an alarm unit; upon receiving the response signal from said target unit, said alarm unit is initiated.

4. The apparatus as claimed in claim 1, wherein the quantity of said target unit is one.

5. The apparatus as claimed in claim 1, wherein said target unit further comprises a s detection activating device; as said search unit draws near to said target unit, said detection activating device is initiated.

6. The apparatus as claimed in claim 1, wherein said target unit further comprises an input device for inputting identification numbers.

7. The apparatus as claimed in claim 1, wherein said search unit further comprises an emitting strength adjustment that allows searching signals to be transmitted at different levels of strength.

8. The apparatus as claimed in claim 1, wherein said search unit further comprises a sensitivity adjustment that provides different levels of sensitivity upon reception.

9. The apparatus as claimed in claim 1, wherein there are at least two target units.
